(19) United States
(12) Patent Application Publication
(10) Pub. No.: US 2013/0307675 A1
(43) Pub. Date: Nov. 21, 2013

(54) WIRELESS CONTROL SYSTEM USABLE WITH PORTABLE ELECTRONIC DEVICE

(71) Applicant: Kuang-Tsu Teng, New Taipei City (TW)

(72) Inventor: Kuang-Tsu Teng, New Taipei City (TW)

(73) Assignee: ASIA VITAL COMPONENTS CO., LTD., New Taipei City, (TW)

(21) Appl. No.: 13/473,579

(22) Filed: May 16, 2012

(51) Int. Cl. G05B 11/01

(52) U.S. Cl. 340/12.3

(57) ABSTRACT

A wireless control system usable with portable electronic device includes at least one controlled device, at least one portable electronic device, and a wireless control device. The portable electronic device is electrically connectable to the wireless control device, and has application software stored therein. The portable electronic device is capable of reading in an operating command to thereby execute the application software that corresponds to the controlled device and generate a remote-control signal. The wireless control device transmits the remote-control signal generated by the portable electronic device to the controlled device for the latter to execute an operation in response to the received remote-control signal. With the above arrangements, the wireless control system is very convenient for use.

### FIELD OF THE INVENTION

The present invention relates to a wireless control system, and more particularly, to a wireless control system usable with a portable electronic device to enable convenient remote control of various electronic products and electric appliances via the portable electronic device.

### BACKGROUND OF THE INVENTION

Most of the currently available electric appliances, such as televisions, video recorders, stereo devices and electric fans, are supplied along with a remote controller for users to conveniently control them remotely. Generally, a remote controller transmits infrared ray for controlling a corresponding electric appliance. The remote controllers provided by electric appliance manufacturers are particularly designed according to the specific models or brands of electric appliances, and therefore use infrared ray of different frequencies to control their corresponding electric appliances. That is, remote controllers designed for different electric appliances are not exchangeable in use. In the case a remote controller supplied by the original manufacturer is failed, the user has to purchase another remote controller also supplied by the original manufacturer. However, electric appliances with new models and brands have been constantly introduced into the market, it is very possible some electric appliances and their corresponding remote controllers are no longer produced, and consumers just could not get new remote controllers for their old electric appliances. To solve this problem, universal remote controllers capable of remotely controlling multiple types of electric appliances have been developed.

While the currently commercially available universal remote controllers can be used to remotely control various kinds of electric appliances and achieve the effect of integrating multiple different remote controllers into one single unit, they also have many disadvantages: (1) Being restricted by the manufacturing cost thereof, the current universal remote controllers are usually preset for use with only some famous or popular brands of electric appliances or provide only very simple setting change function but not smart setting; and (2) a large number of keys is included for covering the functions of multiple different remote controllers, which results in a considerably large size or volume, as well as inconveniences in carrying or using the universal remote controllers.

### SUMMARY OF THE INVENTION

It is therefore a primary object of the present invention to provide a wireless control system usable with portable electronic device to enable convenient remote control of various electronic products and electric appliances via the portable electronic device.

Another object of the present invention is to provide a wireless control system usable with portable electronic device to enable diversified remote control functions and reduction of cost for preparing different remote controllers.

To achieve the above and other objects, the wireless control system usable with portable electronic device according to the present invention includes at least one controlled device, at least one portable electronic device, and a wireless control device. The portable electronic device has a connector, application software stored therein, and a microprocessing unit provided therein. The connector is arranged on one side of the portable electronic device, and the microprocessing unit is capable of reading in an operating command to execute the application software corresponding to the controlled device and generate a remote-control signal to the wireless control device.

The wireless control device has a mating connector provided on one side thereof and a transmitting unit provided on another side thereof. The mating connector is electrically connectable to the connector on the portable electronic device. The transmitting unit wirelessly transmits the remote-control signal received by the wireless control device to a corresponding controlled device, so that the controlled device executes an operation in response to the received remote-control signal. And, the portable electronic device is connectable to the wireless control device by way of hot plug to remotely control the controlled device.

With the above arrangements, the wireless control system of the present invention is usable with a portable electronic device, so that the portable electronic device can be used to effectively remotely control various types and brands of controlled devices to achieve the effects of diversified remote-control functions, reduction of cost for preparing multiple remote controllers, and convenient remote-control operation.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a wireless control system usable with portable electronic device according to a first embodiment of the present invention;

FIG. 2 is a perspective view showing the application of the first embodiment of the present invention;

FIG. 3 is a perspective view showing a portable electronic device and a wireless control device for the first embodiment of the present invention in an assembled state;

FIG. 4 shows the portable electronic device and the wireless control device of FIG. 3 in a separated state;

FIG. 5A is an exploded perspective view showing the portable electrode device and a variant of the wireless control device according to the first embodiment of the present invention in a separated state;

FIG. 5B is an assembled view of FIG. 5A;

FIG. 6 shows another application of the first embodiment of the present invention;

FIG. 7 is a perspective view showing a second embodiment of the present invention, in which the portable electronic device and the wireless control device are connected to each other via a cable; and

FIG. 8 is an exploded view of FIG. 7.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

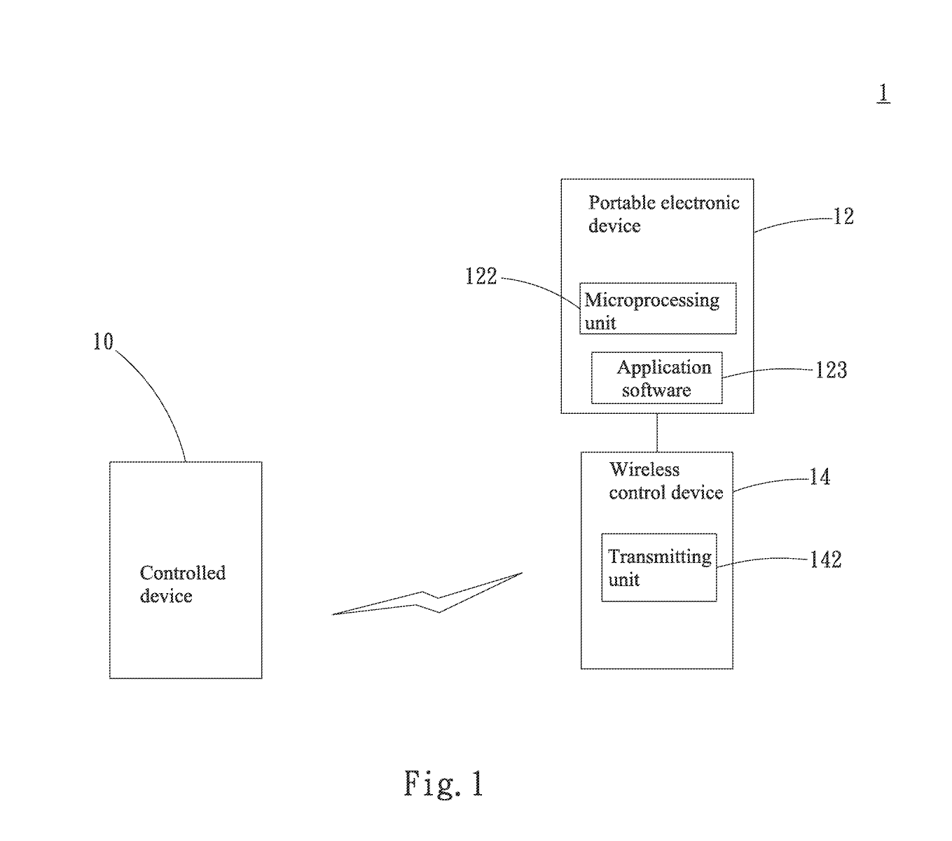

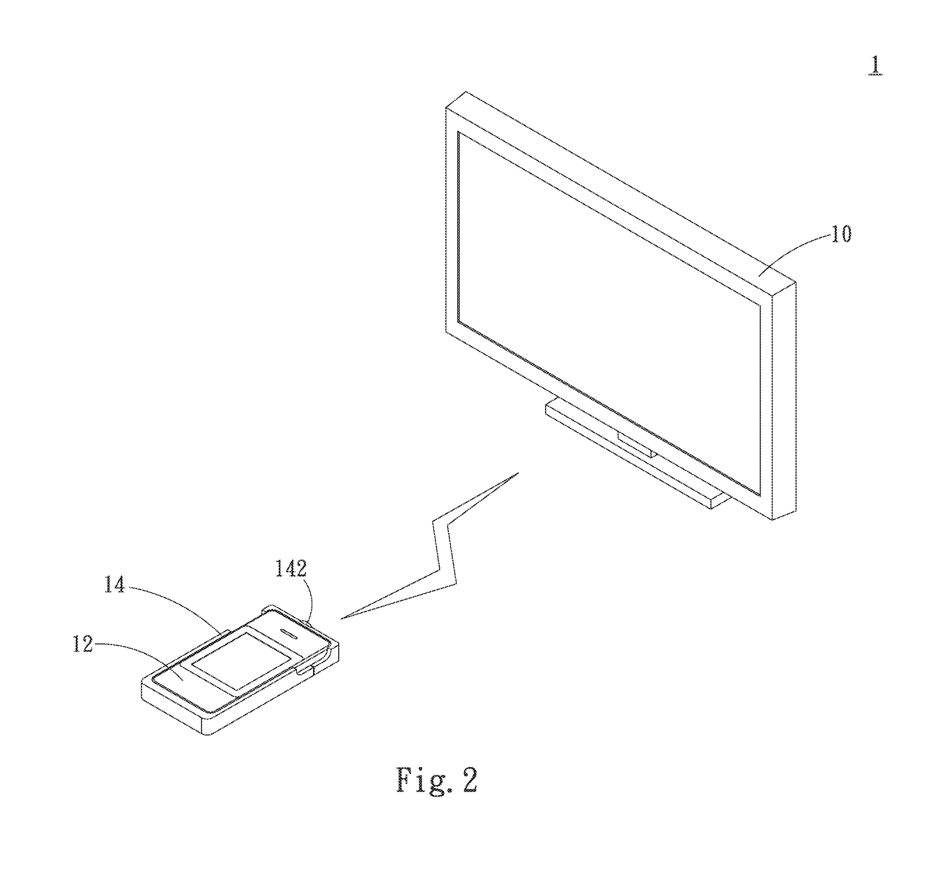

Please refer to FIG. 1 that is a block diagram of a wireless control system usable with portable electronic device according to a first embodiment of the present invention, and to FIG. 2 that shows an application of the first embodiment of the present invention. As shown, the wireless control system, which is generally denoted by reference numeral 1, in the first embodiment includes at least one controlled device 10, at least one portable electronic device 12, and a wireless control device 14. While the portable electronic device 12 referred to in the first embodiment is a smartphone, it is not necessarily limited thereto but can also be a tablet computer, a notebook computer, or a personal digital assistant (PDA) in practical implementation of the present invention.

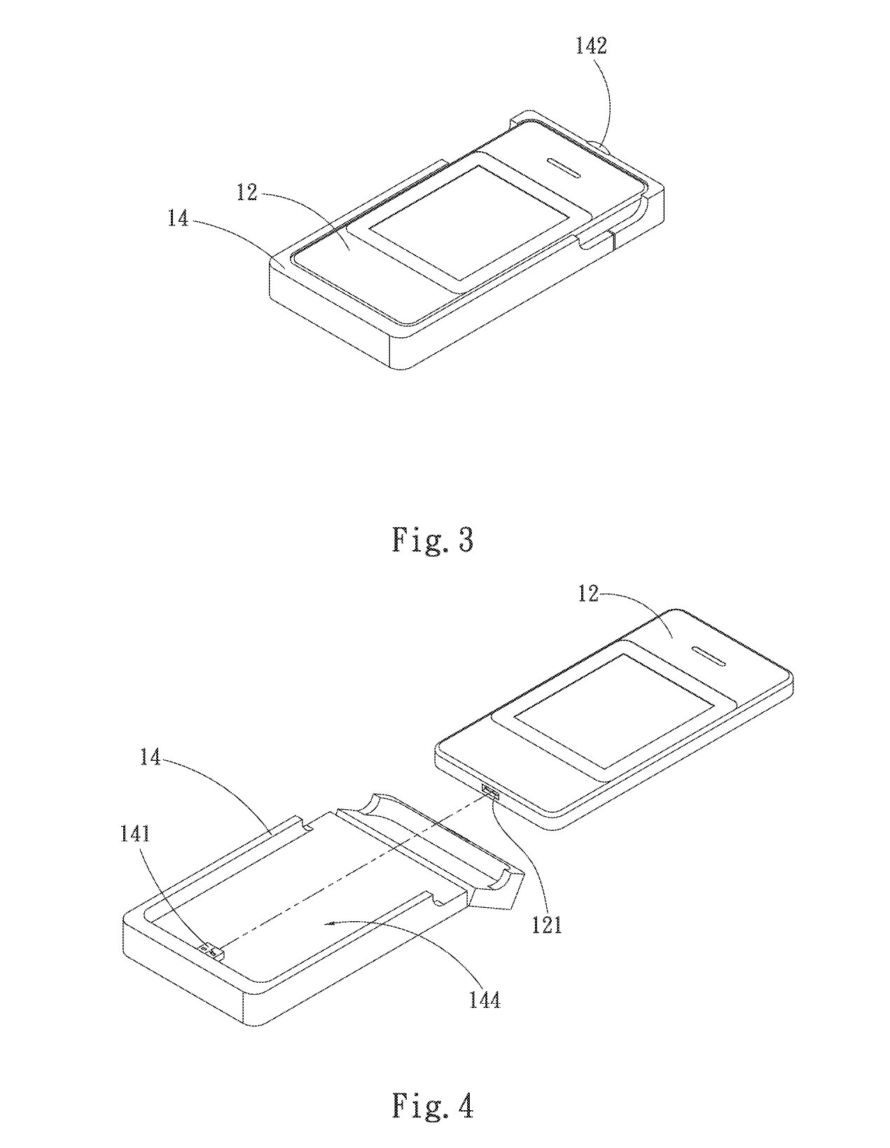

FIGS. 3 and 4 show the portable electronic device 12 assembled to and separated from the wireless control device 14, respectively. As shown, the portable electronic device 12 includes a connector 121, application software 123, and a microprocessing unit 122. The connector 121 is arranged on one side of the portable electronic device 12 and can be a socket or a jack. In the illustrated first embodiment, the connector 121 is described as a connecting port in compliance with universal serial bus (USB) specification without being limited thereto. In practical implementation of the present invention, the connector 121 may be a micro USB port, a mini USB port, a serial advanced technology attachment (serial ATA or SATA) port, an external SATA (e-SATA) port, an RJ-45 port, a high-definition multimedia interface (HDMI) port, a dock port, such as any one of Apple 30-pin iPhone dock, iPod dock and iPad dock, or a 3.5 mm earphone jack.

The application software 123 is stored in the portable electronic device 12, and includes a plurality of remote-control codes corresponding to the encoded data of various controlled devices 10, such as electronic products or electric appliances. That is, the remote-control codes contained in the application software 123 correspond to the encoded data of various electronic products, such as a set-top box and a portable AV camcorder, or of various electric appliances, such as a television, a video recorder, a DVD player, an electric fan, a stereo device and the like. The encoded data are provided for remote control of the controlled devices 10.

Please refer to FIGS. 1 and 2 along with FIGS. 3 and 4. The microprocessing unit 122 is provided inside the portable electronic device 12, and is able to read in an operating command and execute one of the remote-control codes in the application software 123 that corresponds to the encoded data of a target controlled device 10 to thereby generate a remote-control signal. The remote-control signal is a signal having been encoded and modulated by the microprocessing unit 122 to match the format of a signal output by the wireless control device 14 electrically connectable to the portable electronic device 12. For instance, in the event the wireless control device 14 is an infrared control device, the matching remote-control signal will be an infrared remote-control signal.

The wireless control device 14 can be in the form of a case, a cover, a rod, or an antenna. While the illustrated first embodiment describes the wireless control device 14 as an infrared control device, it is understood, in practical implementation of the present invention, the wireless control device 14 can be otherwise a radio-frequency (RF) control device or a laser control device. As shown, the wireless control device 14 includes a mating connector 141, a transmitting unit 142, and a receiving space 144. The mating connector 141 is provided on one side of the wireless control device 14 and can be a plug. That is, the plug is provided in the receiving space 144 of the wireless control device 14 on one side facing toward the connector 121. Alternatively, the plug can be provided on an outer surface of the wireless control device 14 at one end thereof. The receiving space 144 is configured for correspondingly receiving the portable electronic device 12 therein, such that the whole portable electronic device 12 can be protectively enclosed in the wireless control device 14 with only a front face thereof exposed from the receiving space 144. In this manner, the portable electronic device 12 can be effectively protected against invasion or damage by external subjects or foreign matters.

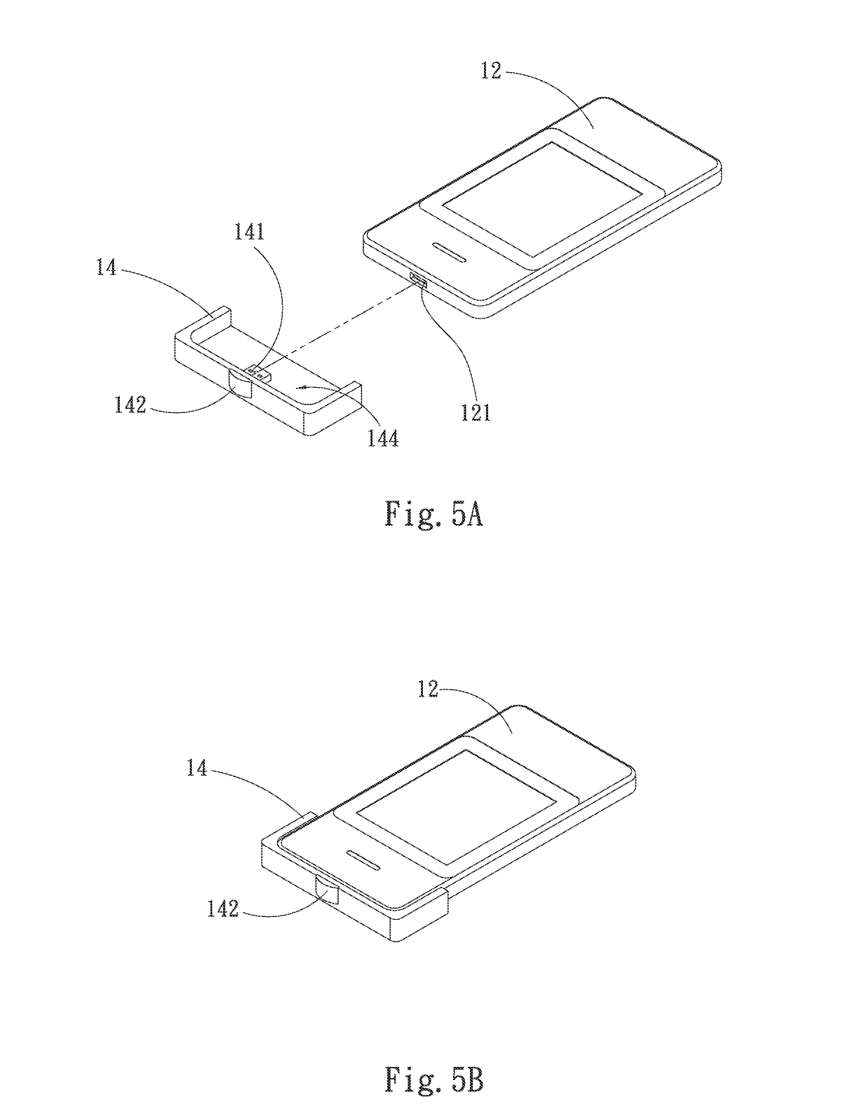

Please refer to FIGS. 5A and 5B. In practical implementation of the present invention, the wireless control device 14 in the form of a case or a cover may be otherwise configured for receiving or covering only part of the portable electronic device 12 to enable easy portability of the wireless control device 14.

The mating connector 141 has a specification matching that of the connector 121. That is, in the illustrated first embodiment of the present invention, the mating connector 141 is described as a connecting port in compliance with USB specification without being limited thereto. In practical implementation of the present invention, the mating connector 141 may be a micro USB port, a mini USB port, a SATA port, an e-SATA port, an RJ-45 port, an HDMI port, a dock port, such as any one of Apple 30-pin iPhone dock, iPod dock and iPad dock, or a 3.5 mm earphone jack. Further, in practical implementation of the present invention, the connector 121 and the mating connector 141 are not necessarily a socket and a plug, respectively. That is, the connector 121 and the mating connector 141 can be exchanged in configuration, so that the connector 121 is a plug and the mating connector 141 is a socket or a jack.

As can be seen from FIGS. 2, 3 and 4, the mating connector 141 is electrically connectable to the connector 121. In the illustrated first embodiment, the electrical connection between the mating connector 141 and the connector 121 is hot plug. That is, the mating connector 141 can be hot-plugged in the connector 121 to achieve the effect of “plug and play”. Moreover, the electrical connection between the mating connector 141 and the connector 121 is not necessarily limited to the above-mentioned hot plug. In practical implementation of the present invention, the mating connector 141 may be electrically connected to the connector 121 through coupling or snapping.

In the illustrated first embodiment, the transmitting unit 142 is described as an infrared element without being limited thereto. That is, the transmitting unit 142 may be an RF element or a laser element. The transmitting unit 142 is provided on the wireless control device 14 at another side thereof for wirelessly transmitting the remote-control signal generated by the portable electronic device 12 to the target controlled device 10, so that the controlled device 10 operates in response to the remote-control signal received. For example, when the controlled device 10 is a television, the received remote-control signal can be a signal for switching TV channels, regulating sound volume, or changing other TV settings.

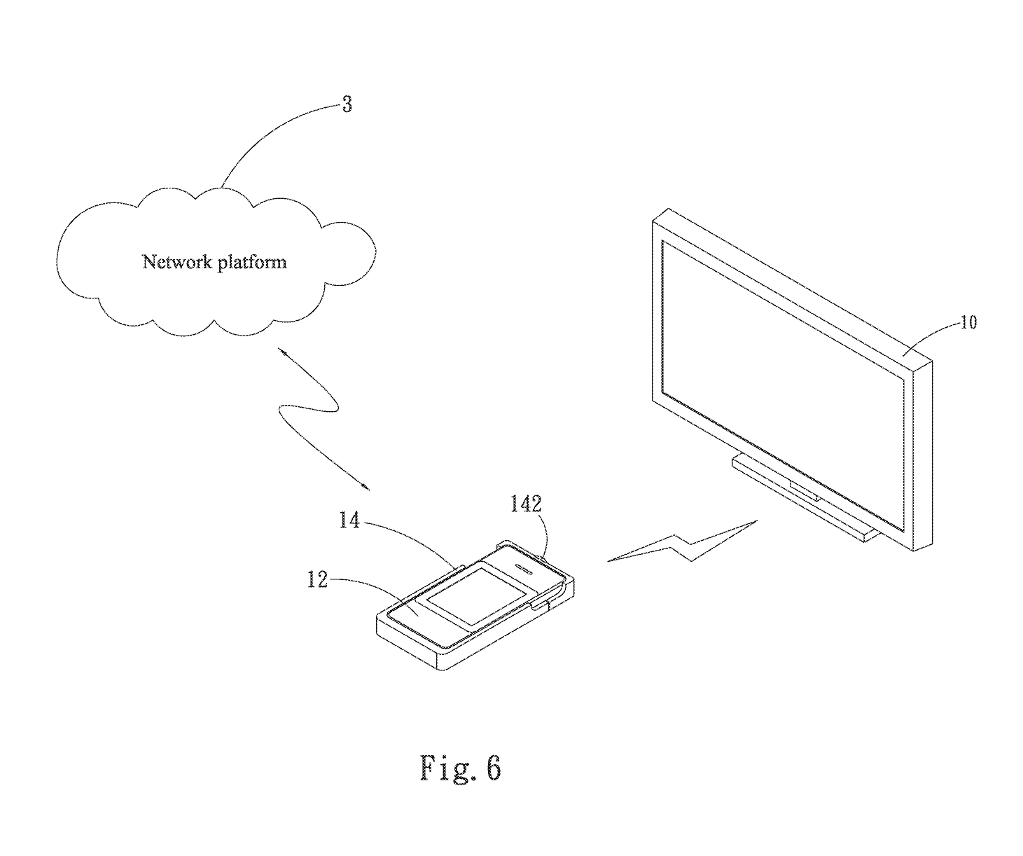

Please refer to FIGS. 1 and 6 at the same time. The portable electronic device 12 can also be wirelessly linked to a network platform 3 to allow downloading, updating or searching for new application software 123 used to remotely control the controlled device 10. When a user's portable electronic device 12 does not include application software 123 for a new controlled device 10, the user may wirelessly link the portable electronic device 12 to the network platform 3 and searches online for any application software 123 of the new controlled device 10. When the desired application software 123 is found, the user may download and install it in the user's portable electronic device 12 to enable remote-control of the new controlled device 10 with the portable electronic device 12 and the wireless control device 14. Therefore, the wireless remote control system 1 of the present invention can be effectively used with various controlled devices 10 to provide good convenience in use and to reduce the cost for preparing a lot of different remote controllers.

The portable electronic device 12 can be wirelessly linked to the network platform 3 via any one of 3G, 4G, WIMAX, WIFI and telekinesis. In the illustrated first embodiment, the network platform 3 is described as an online store, such as Apple Online Store or Android Market, without being limited thereto. In practical implementation of the present invention, the network platform 3 referred to herein may be any platform, such as a server, that allows the portable electronic device 12 to download, update or search for new application software 123 of a corresponding controlled device 10.

With the wireless control system 1 of the present invention, application software 123 for any controlled device 10 that is to be remotely controlled via the portable electronic device 13 and the wireless control device 14 can be effectively and timely downloaded, updated or installed in the portable electronic device 12. Therefore, with the present invention, one single portable electronic device 12 can provide multiple functions to achieve good usability at reduced cost.

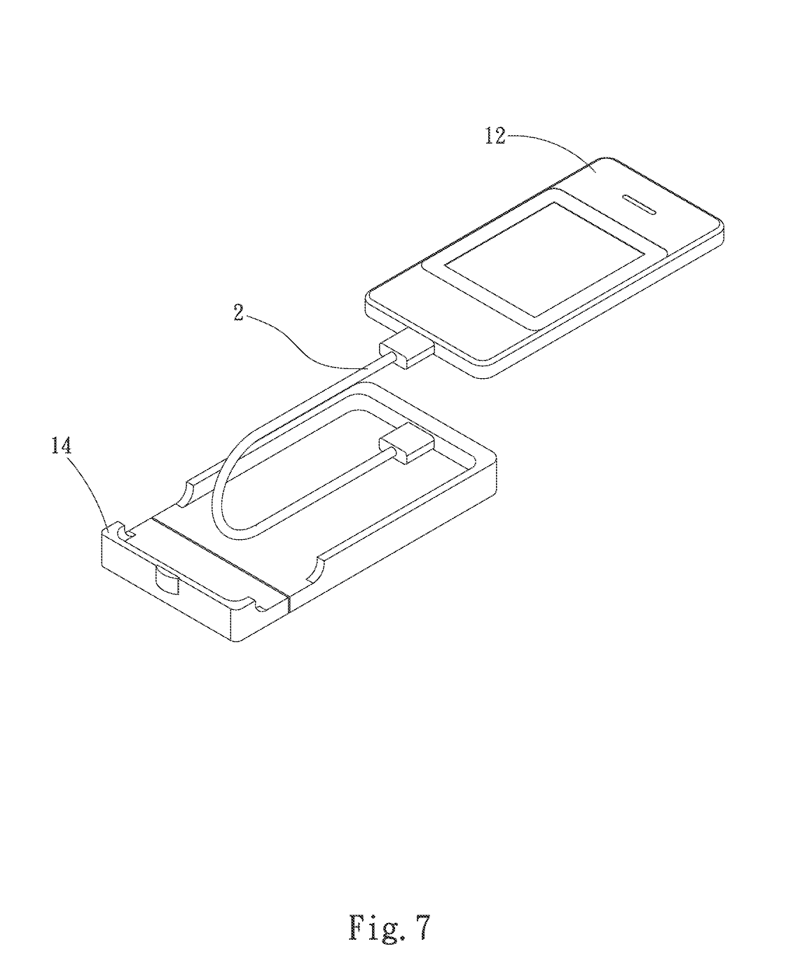

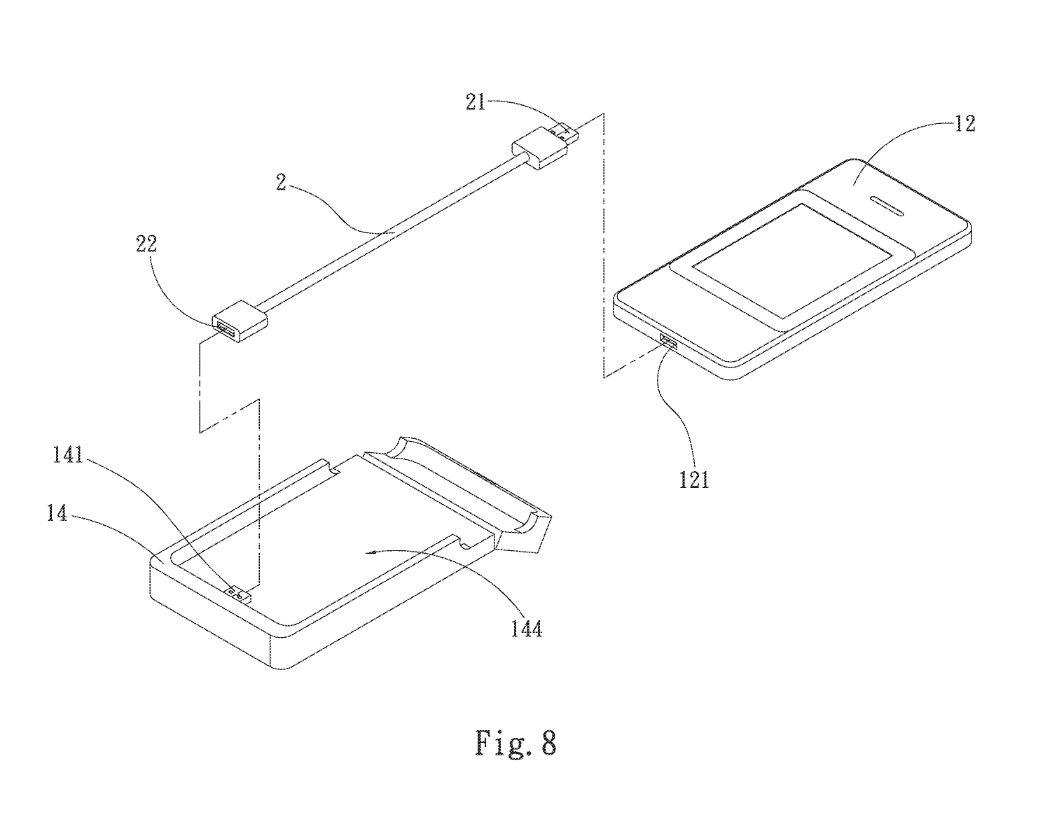

FIGS. 7 and 8 are assembled and exploded perspective views, respectively, showing a second embodiment of the present invention. The second embodiment is generally structurally similar to the first embodiment, except for a further provided cable 2. The cable 2 can be selectively connected to between the connector 121 and the mating connector 141. In the illustrated second embodiment, the cable 2 is described as a cable in compliance with USB specification without being limited thereto.

The cable 2 includes a male connector 21 provided at one end thereof, and a female connector 22 provided at another opposite end thereof. The male connector 21 and the female connector 22 can be electrically connected to the corresponding connector 121 and mating connector 141, respectively, by way of hot plug, so that the remote-control signal generated by the portable electronic device 12 is transmitted to the wireless control device 14 via the cable 2.

In brief, the present invention has the following advantages: (1) highly convenient for use; (2) applicable to various types of controlled devices to achieve diversified remote control functions; and (3) enabling reduction of cost for preparing different remote controllers.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A wireless control system usable with portable electronic device, comprising:
at least one controlled device for executing a corresponding operation in response to a received remote-control signal;
at least one portable electronic device including a connector, application software, and a microprocessing unit provided inside the portable electronic device; the connector being arranged on one side of the portable electronic device; the microprocessing unit being capable of reading in an operating command to thereby execute application software that corresponds to the controlled device, so as to generate the remote-control signal; and
a wireless control device being provided with a mating connector and a transmitting unit; the mating connector being arranged on one side of the wireless control device for electrically connecting to the connector on the portable electronic device; the transmitting unit being arranged on another side of the wireless control device for transmitting the remote-control signal generated by the microprocessing unit to the controlled device.

2. The wireless control system usable with portable electronic device as claimed in claim 1, wherein the connector is a socket and the mating connector is a plug; and the mating connector being connectable to the connector by way of hot plug.

3. The wireless control system usable with portable electronic device as claimed in claim 1, wherein the mating connector is electrically connectable to the connector by way of hot plug.

4. The wireless control system usable with portable electronic device as claimed in claim 1, wherein the connector and the mating connector are a socket and a plug, respectively; and the connector and the mating connector being connectable to each other via a cable; the cable having a male connector provided at one end thereof and a female connector provided at another opposite end thereof; and the male connector and the female connector being respectively electrically connectable to the connector on the portable electronic device and the mating connector on the wireless control device by way of hot plug.

5. The wireless control system usable with portable electronic device as claimed in claim 1, wherein the application software contains a plurality of remote-control codes, and the remote-control codes corresponding to encoded data of the at least one controlled device.

6. The wireless control system usable with portable electronic device as claimed in claim 1, wherein the portable electronic device is wirelessly linkable to a network platform to allow downloading, updating, or searching for application software corresponding to the controlled device to be remotely controlled via the portable electronic device and the wireless control device.

7. The wireless control system usable with portable electronic device as claimed in claim 1, wherein the transmitting unit is selected from the group consisting of an infrared element, a radio-frequency (RF) element, and a laser element.

8. The wireless control system usable with portable electronic device as claimed in claim 1, wherein the connector and the mating connector are connecting ports in compliance with a specification selected from the group consisting of USB specification, micro USB specification, mini USB specification, SATA specification, e-SATA specification, RJ-45 specification, HDMI specification, and various dock specifications.

9. The wireless control system usable with portable electronic device as claimed in claim 1, wherein the portable electronic device is selected from the group consisting of a smartphone, a tablet computer, a notebook computer, and a PDA.

10. The wireless control system usable with portable electronic device as claimed in claim 6, wherein the network platform is selected from the group consisting of online stores and servers.

11. The wireless control system usable with portable electronic device as claimed in claim 6, wherein the portable electronic device is wirelessly linkable to the network platform via any one of 3G, 4G, WIMAX, WIFI and telekinesis.

12. The wireless control system usable with portable electronic device as claimed in claim 1, wherein the wireless control device defines a receiving space for the portable electronic device to fit therein; and the mating connector being arranged in the receiving space on one side facing toward the connector on the portable electronic device.
